(19) United States
(12) Patent Application Publication
(10) Pub. No.: US 2026/0225359 A1
(43) Pub. Date: Aug. 6, 2026

(54) LAMINATING APPARATUS FOR LAMINATING MULTILAYER ENDLESS WEBS FOR PRODUCING ENERGY CELLS

(71) Applicant: KÖRBER TECHNOLOGIES GMBH, HAMBURG (DE)

(72) Inventors: Michael KLEINE WÄCHTER, Lankau (DE); Manfred FOLGER, Hamburg (DE); Dennis SPRINGBORN, Hamburg (DE); Niko ROSSFELDT, Börnsen (DE); Marco EL GENDY, Bargteheide (DE)

(21) Appl. No.: 19/123,088

(22) PCT Filed: Oct. 17, 2023
(86) PCT No.: PCT/EP2023/078818

§ 371 Date: Apr. 22, 2025

(30) Foreign Application Priority Data
Oct. 25, 2022 (DE) 10 2022 128 222.8

(51) Int. Cl. B32B 37/10; B32B 38/00

(52) U.S. Cl. CPC B32B 37/1027; B32B 38/0036; B32B 2309/12; B32B 2457/10; B32B 2457/18

(57) ABSTRACT

The invention relates to a laminating apparatus for a multilayer endless web (3) composed of at least one separator web (4, 6) and at least one electrode for producing energy cells using a pressing device which laminates the multilayer endless web (3) over a pressing surface by exerting a compressive force. The pressing surface has various portions having a different spring stiffness.

The present invention relates to a laminating apparatus for laminating multilayer endless webs for producing energy cells having the features of the preamble of claim 1.

Energy cells or energy storage devices within the meaning of the invention are used, for example, in motor vehicles, other land vehicles, ships, aircraft or also in stationary systems such as photovoltaic systems, in the form of battery cells or fuel cells in which very large amounts of energy have to be stored over longer periods of time.

For this purpose, such energy cells may have a structure consisting of a plurality of segments stacked to form a stack. These segments are each formed from alternating anode sheets and cathode sheets, which are separated from each other by separator sheets that are also produced as segments. The segments are pre-cut in the production process and then placed on top of each other in the predetermined sequence to form the stacks and joined together by lamination. The anode sheets and cathode sheets are first cut from an endless web and then placed individually at intervals on an endless web of separator material. This subsequently formed “two-ply” endless web made of the separator material with the anode sheets or cathode sheets placed on top is then cut into segments again in a second step by means of a cutting apparatus, wherein the segments in this case are formed in a double layer by a separator sheet with an anode sheet or cathode sheet arranged on top. If this is technically feasible or necessary from a manufacturing perspective, the endless webs of separator material with the anode sheets and cathode sheets placed on top of each other can also be placed on top of each other before cutting, so that an endless web is formed with a first endless layer of separator material with anode sheets or cathode sheets placed thereon and a second endless layer of separator material with anode sheets or cathode sheets placed thereon. This “four-ply” endless web is then cut into segments by means of a cutting apparatus, which segments are in this case formed in four layers with a first separator sheet, an anode sheet, a second separator sheet and a cathode sheet lying thereon. The advantage of this solution is that one cut can be saved. Furthermore, the cut electrodes can also be placed on an endless separator web and stacked on top of each other by another endless separator web to form a three-ply endless web, from which three-ply segments with a separator sheet, an electrode sheet and another separator sheet are then cut. “Segments” within the meaning of this invention are therefore single-ply segments of a separator material, anode material or cathode material, or also two-ply, three-ply or four-ply segments of the structure described above.

Furthermore, the “two-ply” or “four-ply” endless webs described above can also be supplemented by placing another separator web on the electrodes to form a “three-ply” or “five-ply” endless web, which then has a separator web on both sides.

Alternatively, the electrodes can also be provided as endless webs, i.e., uncut in the “two-ply”, “three-ply”, “four-ply” or “five-ply” endless webs, which are then cut to considerably longer lengths and then wound up, for example. Alternatively, the endless webs can be wound first and then cut after winding is complete. In this case, the electrodes in the endless webs are not present as spaced segments, but instead in a single segment that extends without interruption in the intermediate space between the separator webs.

Furthermore, an electrode in the form of a copper web or copper foil or a comparable carrier material with an intermittent coating can also be provided in the endless web, in which the coatings each form sectional, spaced apart elevations in the electrode. To laminate the “two-ply,” “three-ply,” “four-ply” or “five-ply” endless webs, they are passed between two pressing devices which exert a compressive force on the endless webs. The electrodes are compressed with the separator webs in these endless webs. In principle, the electrodes are connected and laminated to the separator webs using a pressing device by exerting a compressive force. In addition, lamination can be assisted by the generation of heat as a result of the compressive force. Furthermore, additional heating or cooling zones can be provided which regulate the temperature of the endless webs during lamination. In order to achieve a high-quality connection, it is desirable that the endless webs are exposed to as equal a compressive force as possible over their longitudinal and transverse extension.

If the electrodes in the endless webs are already arranged at intervals from each other in the form of cut segments, the electrodes form additional intermediate spaces in the endless webs due to their spacing, whereby the electrodes additionally keep the separator webs at an interval from each another in the intermediate spaces due to their thickness. This means that the electrodes have additional free edges on the edges bordering the intermediate spaces. Furthermore, the endless web exhibits additional variations in thickness.

This means that the endless web to be laminated has a varying thickness, which results solely from the unavoidable manufacturing inaccuracies of the electrodes and separator webs in their thicknesses and/or from the spacing of the electrodes. Furthermore, the electrodes can be narrower than the separator webs, so that the arrangement of the electrode in the endless web also results in different thicknesses of the endless web in the region of the edge portions of the endless web.

These variations in thickness of the endless web lead to dynamic stress on the pressing device in the laminating apparatus. Furthermore, the variations in thickness lead to variations in the pressing forces exerted by the pressing device on the endless web and to increased compressive loads on the free edges with the risk of edge damage.

Against this background, the invention is based on the object of creating a laminating apparatus which allows the endless webs to be laminated with a contour-adapted pressing force and a reduced dynamic load on the pressing device.

According to the invention, a laminating apparatus having the features of claim 1 is proposed to achieve the object. Further preferred refinements of the invention can be found in the dependent claims, the figures, and the associated description.

According to the fundamental concept of the invention, it is proposed that the pressing surface has various portions having a different spring stiffness. As a result of the different spring stiffnesses, the pressing surface can be specifically designed so that it is stiffer in predetermined portions and thus transmits a higher compressive force, while it transmits a lower compressive force in the portions with the lower spring stiffness. In particular, differences in thickness in the endless web due to the arrangement of the electrode in the endless web can be compensated for by deliberately allowing the pressing surface to yield and compress more in the portions with the lower spring stiffness than in the portions with the higher spring stiffness. As a result, the variations in thickness have less influence on the pressing force, as they are compensated for by the contour-adapted pressing force, so that lamination takes place with a much more constant pressing force acting on the endless web. By adjusting the pressing force in portions synchronously with the variations in thickness of the endless web, zones of higher and lower pressure can be created and thus the cohesion forces as a result of lamination can be specifically influenced. Particularly in the regions with free edges, the pressing forces can be reduced synchronously with the variations in thickness and free edges in order to avoid damage to the free edges without increasing the dynamic load on the overall system by allowing the pressing surface to yield and compress more in the portions with lower spring stiffness than in the portions with higher spring stiffness.

It is further proposed that the pressing device laminates the multilayer endless web in the laminating apparatus by the application of heat. The lamination, i.e., the connection of the endless webs of separator material to each other and to the electrodes, is achieved by polymers penetrating from one layer into the other, which in turn is caused by the adhesion forces acting at the interfaces. It is precisely these adhesion forces that can be achieved more easily by the application of heat. However, care must be taken to ensure that the material in the interfaces is not compressed to such an extent by the application of heat and the acting compressive force that the ion exchange, which is important for the function of the energy cell, is prevented.

The different spring stiffness can preferably be achieved by a resilient support of the pressing surface in the pressing device. The different spring stiffness achieved by the resilient support of the pressing surface can be achieved by individual resiliently mounted segments in the pressing surface in an otherwise non-resilient pressing surface, or by a plurality of resiliently mounted segments with different spring stiffnesses.

Furthermore, the different spring stiffness can be realized additionally or alternatively by different spring stiffnesses of the material of the pressing surface. This can be achieved, for example, by a locally different arrangement of stiffening material components or a locally different combination of different materials in the pressing surface and/or by dimensioning the pressing surface in different thicknesses.

It is further proposed that the electrode has a smaller width than the separator web in the longitudinal direction of the endless web, and that the pressing surface in the region with which it covers at least one protruding edge of the separator web has a higher or lower spring stiffness than in the region with which it covers the electrodes. The proposed solution laminates the endless web in at least one edge region with a higher compressive force than in the region of the electrodes. This results in a stronger bond between the endless web in the edge region and at the same time a lower load on the electrodes. Furthermore, the spring stiffness can be designed to be lower instead of higher, so that the pressing surface deliberately yields more in the region of the protruding edges of the separator web. Since the endless web itself is designed to be “softer” in the region of the edges of the separator web due to the lack of a resistance surface otherwise formed by the electrodes, the pressing surface deliberately exerts a lower pressing force in these portions.

It is further proposed that a plurality of electrodes arranged at regular intervals from each other are provided in the endless web. The endless web is thus prefabricated for the production of individual multilayer segments, each with one electrode or a pair of electrodes. To produce the segments, the endless web then only needs to be cut into the individual segments by a cutting process. If the endless web has an intermittent coating, the coated portions correspond to the electrodes and the distances between the coatings correspond to the intervals between the electrodes.

In this case, it is further proposed that the pressing surface in the portion with which it comes into contact with the endless web in the region of the intervals between the electrodes has a higher or lower spring stiffness than in the portion with which it comes into contact with the endless web in the region of the electrodes. As a result of the higher spring stiffness in the region of the intervals between the electrodes, the endless web is exposed to a relatively higher pressing force in these portions than in the region of the electrodes. The pressing surface can therefore deliberately yield more in the region of the electrodes than in the regions of the intermediate spaces or intervals between the electrodes, so that the electrodes are protected during lamination and the separator webs are laminated better in the region of the intermediate spaces. The pressing surface thus has a distribution of portions with a higher spring stiffness corresponding to the arrangement of the intermediate spaces and a distribution of portions with a lower spring stiffness corresponding to the distribution of the electrodes. Furthermore, the spring stiffness can be designed to be lower instead of higher, so that the pressing surface deliberately yields more in the portion with which it comes into contact with the endless web in the region of the intervals between the electrodes. Since the endless web itself is designed to be “thinner” in the region of the intervals due to the lack of a resistance surface otherwise formed by the electrodes, the pressing surface deliberately exerts a lower pressing force in these portions.

It is further proposed that the pressing device comprises at least one pressing roller with a circular cross section, and the pressing surface is formed by the lateral surface of the pressing roller. The proposed design of the pressing device allows the laminating apparatus to be preferably integrated into a drum run, which in turn allows a very high production capacity. The lateral surface of the pressing roller also forms a particularly advantageous pressing surface, since it can be produced very precisely and, by rolling along the endless web, allows linear pressing of the continuous endless web across its entire width.

At least one radially resiliently mounted lateral segment can be provided in the lateral surface, the radially outer surface of which forms part of the pressing surface. The pressing surface thus deflects locally in the region of the lateral segment, so that the compressive force for laminating the endless web is lower in these portions. For this purpose, the lateral segments can be arranged and dimensioned such that they cover the electrodes when they roll along the endless web, so that the electrodes are deliberately relieved of pressure during lamination, or in other words, the endless web is laminated with a higher compressive force in the region of the intermediate spaces than in the region of the electrodes. Furthermore, the resilient lateral segments can also be arranged such that the electrodes are specifically relieved in the region of their edges.

It is further proposed that the pressing device has at least one pressing belt, and the pressing surface is formed by the surface of the pressing belt with which it rests against the endless web by exerting a compressive force. The use of a pressing belt in the pressing device to create the pressing surface has the advantage that the compressive force during lamination can be generated by any pressure-generating device and distributed via the pressing belt to the endless web in a distribution defined by the shape and design of the pressing belt. As a result of its belt shape, the pressing belt has the advantage that the force transmission region can be increased over a greater length of the endless web.

In this case, the pressing belt can have different spring stiffnesses along its longitudinal extension in the direction of the exerted compressive force. The pressing belt therefore has zones that are harder and zones that are deliberately designed to be softer. The pressing belt can thus adapt to the differences in thickness of the endless web, so that the endless web is subjected to less stress in the zones of greater thickness. The pressing belt can give better yield in these zones, e.g., the zones of the system on the endless web in which the electrodes are arranged, so that the pressure peaks during lamination can be reduced.

The pressing roller can preferably rest on the free side of the pressing belt and press the pressing belt against the endless web by exerting a compressive force. In this case, the pressing roller is the pressure-generating device with the advantages described above, which are then combined with the advantages of using a pressing belt to form a further improved solution.

According to an advantageous further development, it is proposed that the pressing roller and/or the pressing belts are or will be moved and/or driven synchronously with the endless web.

Through the synchronous movement of the endless web with the pressing roller and/or pressing belts, the cohesion forces can be influenced accordingly. In this way, the pressing forces can be reduced, for example in the regions with free edges, synchronously with the variations in thickness and free edges.

The invention is explained below using preferred embodiments with reference to the accompanying figures, in which:

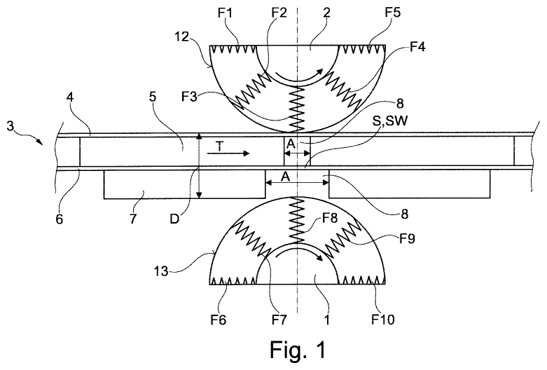

FIG. 1 shows a section of a laminating apparatus with a four-ply endless web and a pressing device with two pressing rollers; and

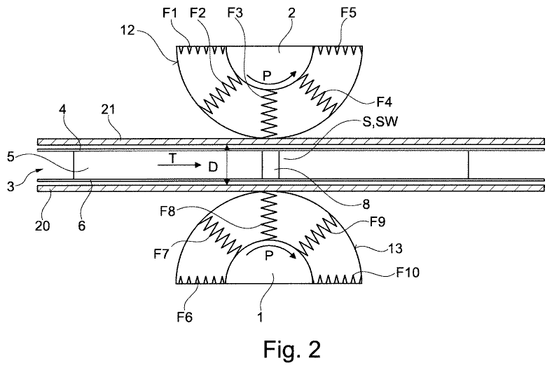

FIG. 2 shows a section of a laminating apparatus with a three-ply endless web and a pressing device with two pressing rollers and two pressing belts.

FIG. 1 shows a section of a laminating apparatus according to the invention, in which the endless web 3 is formed by a “four-ply” endless web 3 with a separator web 4 on the upper side and a separator web 6 in the middle, a plurality of anodes 5 arranged between the separator webs 4 and 6, and a plurality of cathodes 7 arranged under the central separator web 6. The anodes 5 are larger than the cathodes 7, so that the anodes 5, when arranged in pairs with the cathodes 7, have a smaller frontal interval A from each other than the cathodes 7. The laminating apparatus further comprises a pressing device with two pressing rollers 1 and 2, which are designed as cylindrical drums with a circular cross section. The pressing rollers 1 and 2 are aligned with their axes of rotation parallel to each other and arranged such that there is a gap S between their lateral surfaces 12 and 13 with a gap width SW that is constant in the direction of the axes of rotation, i.e., perpendicular to the plane of representation.

The gap width SW of the gap S is smaller than the thickness D of the endless web 3, so that the endless web 3 is slightly compressed and laminated when passing through the gap S. The thickness D2 of the separator webs 4 and 6 is 15 to 25 μm, while the electrodes 5 have a thickness D1 of 150 to 400 μm. This results in a thickness D of the electrode web 3 of approximately 330 μm to 850 μm. The gap width SW is 20 to 100 μm, preferably 40 to 60 μm, smaller than the thickness D of the endless web, so that the endless web 3 is slightly compressed by 5 to 10 μm when passing through the gap S. The intermediate spaces 8 are formed by the spacing of the electrodes and have a height which corresponds to the thickness D1 of the electrodes, i.e., 150 to 400 μm. Furthermore, the intermediate spaces 8 have a length in the feed direction corresponding to the interval A of the electrodes 5 of 3 mm between the anodes and 6 mm between the cathodes, wherein it is desirable to make the intervals A between the electrodes 5 as small as possible in order to increase the material utilization rate of the endless web 3 and the number of electrodes 5 in a predetermined length of the endless web 3.

The endless web 3 is transported in the feed direction T and pulled through the gap S. The pressing rollers 1 and 2 can themselves be actively driven, for example by individual drives in the form of servo motors, to rotate in opposite directions in the direction of the arrows P, so that they also actively transport the endless web 3 through the frictional connection. Alternatively, the pressing rollers 1 and 2 can also be mounted so that they can only rotate, so that they themselves are driven by the endless web 3 through the frictional connection to the rotary movements. In this case, the pressing rollers 1 and 2 roll only passively on the surfaces of the endless web 3.

The lateral surfaces 12 and 13 of the pressing rollers 1 and 2 form the pressing surfaces of the pressing device. The lateral surface 12 of the upper pressing roller 2 is spring-loaded by a plurality of springs F1 to F5 with different spring stiffnesses, so that it yields differently depending on the angle of rotation of the pressing roller 2 and the contact position defined thereby on the endless web 3. The same applies to the lower pressing roller 1 in the illustration with its springs F6 to F10 which act on the lateral surface 13.

FIG. 2 shows an alternative embodiment of the invention. In addition to the two pressing rollers 1 and 2, the pressing device here also comprises two pressing belts 20 and 21, which rest on the upper side and the lower side of the endless web 3. The pressing rollers 1 and 2 are here identical to the pressing rollers 1 and 2 in FIG. 1 and rest on the free surfaces of the two pressing belts 20 and 21.

Furthermore, an endless web 3 to be laminated is provided, which runs through the gap S and has a thickness D. The endless web 3 is formed by a “three-ply” endless web 3 with a separator web 4 on the upper side and a separator web 6 on the lower side and anodes 5 arranged in between. The anodes 5 are arranged with intermediate spaces 8 at identical intervals A from each other and have a smaller width than the separator webs 4 and 6, so that the separator webs 4 and 6 project laterally beyond the anodes 5.

Since the anodes 5 are fundamentally larger than the cathodes 7 in the energy cell, but the separator webs 4 and 6 are identical and serve to arrange both the anodes 5 and the cathodes 7 shown in FIG. 1, the intervals A between the intermediate spaces 8 between the cathodes 7 and the free lateral edge zones are particularly large for the cathodes 7. Conversely, the intervals A between the intermediate spaces 8 and the free edge sides are smaller for the anodes 5.

The springs F1 to F10 in the pressing rollers 1 and 2 are dimensioned such that the pressing surfaces formed by the lateral surfaces 12 and 13 are specifically stiffer in certain portions of the circumference and specifically softer in other portions, in that the springs F1 to F10 have different spring stiffnesses. This means that the pressing surfaces can yield differently due to the unavoidable variations in thickness of the endless web 3, for example as a result of the intermediate spaces 8. This allows the endless web 3 to be laminated with lower pressure peaks and a reduced load on the electrodes 5, in particular in the region of the edges adjacent to the intermediate spaces 8.

In the embodiment of FIG. 2, two additional pressing belts 20 and 21 are provided in addition to the pressing rollers 1 and 2. According to the embodiment of FIG. 1, a plurality of springs F1 to F10 with different spring stiffnesses are provided in the pressing rollers 1 and 2. Alternatively or additionally, the pressing belts 20 and 21 can also be designed with different spring stiffnesses in the direction in which the pressing forces are exerted on the endless web 3. For this purpose, the pressing belts 20 and 21 can be implemented, for example, as textile belts with local fiber reinforcements or other combinations of different materials. Furthermore, individual lateral segments can also be provided in the lateral surfaces 12 and 13 of the pressing rollers 1 and 2, which form a portion of the lateral surface 12 and 13 with their surfaces and are separately resiliently mounted. It would also be conceivable to use a rod carpet, a piston-cylinder unit, a pneumatically operated pressure device, e.g., with an inflatable cushion as a pressure-generating device instead of the pressing rollers 1 and 2. In particular, fiber-reinforced textile belts, steel belts or very fine link belts can be used as pressing belts 20 and 21.

The laminating apparatus can be designed such that the pressing device has a distribution of spring stiffnesses in the pressing surfaces that is adapted to a thickness distribution of the endless web 3 to be laminated, wherein in particular the dimensions of the electrodes 5 and the position of the intermediate spaces 8, including the intervals A between the electrodes in the intermediate spaces 8, are taken into account.

1. A laminating apparatus for a multilayer endless web composed of at least one separator web and at least one electrode for producing energy cells using
a pressing device which laminates the multilayer endless web over a pressing surface by exerting a compressive force, wherein
the pressing surface has various portions having a different spring stiffness.

2. The laminating apparatus according to claim 1, wherein
the pressing device laminates the multilayer endless web by the application of heat.

3. The laminating apparatus according to claim 1, wherein
the different spring stiffness is realized by a resilient support of at least one portion of the pressing surface in the pressing device.

4. The laminating apparatus according to claim 1, wherein
the different spring stiffness is realized by different spring stiffnesses of the material of the pressing surface.

5. The laminating apparatus according to claim 1, wherein
the electrode has a smaller width in the longitudinal direction of the endless web than the separator web, and
the pressing surface in the region with which it covers at least one protruding edge of the separator web has a higher or lower spring stiffness than in the region with which it covers the electrodes.

6. The laminating apparatus according to claim 1, wherein
a plurality of cut electrodes arranged at regular intervals from each other are provided in the endless web.

7. The laminating apparatus according to claim 6, wherein
the pressing surface in the portion with which it comes into contact with the endless web in the region of the intervals between the electrodes has a higher or lower spring stiffness than in the portion with which it comes into contact with the endless web in the region of the electrodes.

8. The laminating apparatus according to claim 1, wherein
the pressing device comprises at least one pressing roller having a circular cross section, and
the pressing surface is formed by the outer surface of the pressing roller.

9. The laminating apparatus according to claim 8, wherein
at least one radially resiliently mounted lateral segment is provided in the lateral surface, the radially outer surface of which forms part of the pressing surface.

10. The laminating apparatus according to claim 1, wherein
the pressing device has at least one pressing belt, and the pressing surface is formed by the surface of the pressing belt with which it rests against the endless web by exerting a compressive force.

11. The laminating apparatus according to claim 10, wherein
the pressing belt has different spring stiffnesses along its longitudinal extension in the direction of the exerted compressive force.

12. The laminating apparatus according to claim 10, wherein
the pressing roller rests on the free side of the pressing belt and presses the pressing belt against the endless web by exerting a compressive force.

13. The laminating apparatus according to claim 8, wherein
the pressing roller and/or the pressing belts are or will be moved and/or driven synchronously with the endless web.

14. The laminating apparatus according to claim 10, wherein
the pressing roller and/or the pressing belts are or will be moved and/or driven synchronously with the endless web.
